(19) United States
(12) Patent Application Publication
(10) Pub. No.: US 2010/0065185 A1
(43) Pub. Date: Mar. 18, 2010

(54) DOUBLE-SIDED PRESSURE-SENSITIVE TAPE

(75) Inventors: Marc Husemann, Hamburg (DE); Markus Peters, Verden (DE)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: TESA SE, Hamburg (DE)

(21) Appl. No.: 12/596,699

(22) PCT Filed: Apr. 4, 2008
(86) PCT No.: PCT/EP08/54086

§ 371 Date: Nov. 30, 2009

(30) Foreign Application Priority Data
Apr. 20, 2007 (DE) 10 2007 019 131.8

(51) Int. Cl. B32B 37/00; B32B 33/00

(52) U.S. Cl. 156/60; 428/220

(57) ABSTRACT

An adhesive tape bonds a reflecting film in a rear illumination unit of a liquid crystal display system. The adhesive tape has a backing film layer and two pressure-sensitive adhesive composition layers with a total thickness (average value) of less than 30 μm and a standard deviation of the total thickness of less than 1.25 μm.

The invention relates to double-sided pressure-sensitive adhesive tapes for bonding reflective films in backlighting units of LC displays.

Pressure-sensitive adhesive (PSA) tapes in the age of industrialization are widespread processing auxiliaries. More particularly for use in the electronics industry, very exacting requirements are imposed on PSA tapes. They are to display little outgassing behaviour and to be capable of use across a wide temperature range, to exhibit low manufacturing tolerances, and to guarantee extremely high bond strengths for an extremely low overall thickness.

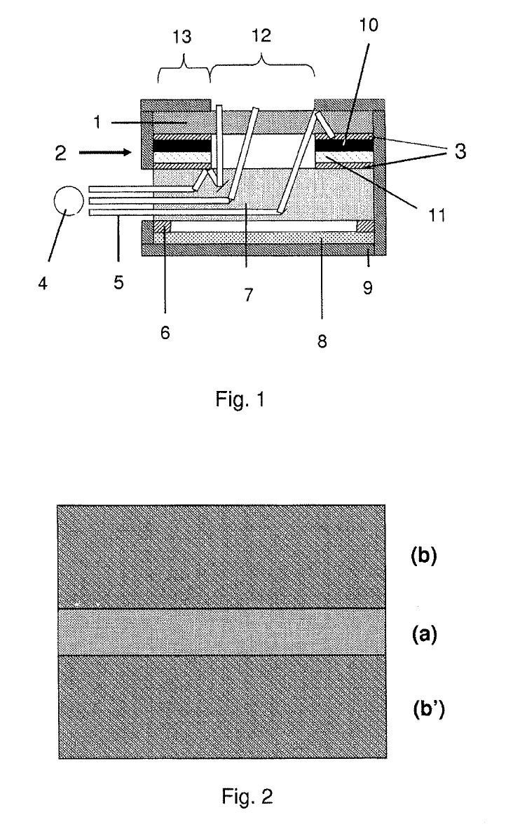

One field of use is that of liquid-crystal data display systems (liquid crystal displays, LC displays, LCDs) which are needed for computers, TVs, laptops, PDAs, mobile phones, digital cameras, etc. One very widespread type of LCD module for such applications is depicted exemplarily in FIG. 1, where the reference numerals show the following:

1 LCD glass

2 double-sided black-white adhesive tape

3 PSA

4 light source (LED)

5 light beams

6 double-sided adhesive tape

7 optical waveguide

8 reflective film

9 LCD housing

10 black absorbing side of adhesive tape

11 reflecting side

12 visible region

13 “blind” region

For the production of LC displays the backlighting unit is bonded to the actual LC display. As part of ongoing miniaturization it is increasingly becoming necessary for the designers to make the overall LC display construction thinner and thinner.

Installed in the housing of the backlighting unit is a reflective film which fulfills the function of uniformly reflecting the light emitted by the light-emitting diode unit (LED unit) to the LC display. Here it is necessary to achieve extremely uniform light distribution in order that no bright light spots can be seen in the display afterwards. One prerequisite for this is a very good flat lie on the part of the reflective film, since otherwise light reflection is disrupted by unevennesses. Consequently this reflective film is fixed—in order, for example, to avoid air inclusions between it and the housing—using, preferably, a double-sided adhesive tape.

The fixing of the backlighting unit in the housing is frequently done by means of double-sided adhesive tapes, which must meet the aforementioned requirements with regard to flat lie. It had therefore been assumed to date that these adhesive tapes had to have sufficient stability, with the consequence that only double-sided adhesive tapes with sufficiently strong and stable carrier films were to be used for the purpose. A disadvantage of such carrier films, however, is that they also always have thickness tolerances, in other words do not have a precise thickness over their entire area. On the other hand, it was expected that very thin films would not have sufficient stability, and would therefore become wavy and hence also would be unable to guarantee flatness. Strong dilution of the adhesive layers was also not considered, since in accordance with expectation it ought to lead to poor bond strengths and hence the required strength of the bond structure of the reflective film on the housing did not appear to be ensured.

It is an object of the invention, therefore, more particularly for use for bonding reflective films in backlighting units of LC displays, to offer a double-sided pressure-sensitive adhesive tape with which the thickness tolerances are minimized and which features an improved alternative to the prior-art adhesive films.

The application requires, more particularly, double-sided adhesive tapes with an extremely low overall thickness, extremely low thickness tolerances, and effective processing qualities in the adhesive bonding operation.

In the context of this invention it has surprisingly been found that double-sided PSA tapes with very thin carrier films have the necessary stability for the processing operation, allow high bond strength for low overall thickness, and are therefore extremely suitable for the bonding of reflective films in backlighting units.

The invention accordingly provides double-sided pressure-sensitive adhesive tapes which have a multi-layer construction and have an overall thickness (average) of less than 30 μm. PSA tapes more particularly suitable for solving the problem addressed by the invention are those whose overall thickness (average) is <25 μm, preferably <20 μm, more preferably <10 μm, very preferably <5 μm.

Overall thickness for the purposes of this specification is the arithmetic averaging across the individual measurement values (cf. experimental section).

Another criterion for the PSA tapes of the invention is their flatness, in other words the uniformity of the adhesive tape's thickness (of the overall thickness). This can be indicated by means of the standard deviation s according to

$$s = \sqrt{\frac{1}{n} \cdot {\sum }_{i = 1}^{n} {( {x}_{i} - \overline{x} )}^{2}}$$

where n is the number of data values determined, xᵢ indicates the individual measurement values, and x indicates the average of all the measurement values. The lower s is, the more uniform the adhesive tape is in terms of its thickness.

The value of 4s (in other words four times the standard deviation s) is frequently termed the layer thickness tolerance, specification limit or else maximum deviation in thickness tolerance.

The adhesive tape of the invention more particularly possesses a layer thickness tolerance 4s of <5 μm; preferably <3 μm, more preferably <2.5 μm, very preferably <2 μm, and thus has a very high degree of uniformity in overall thickness.

In this relationship, low standard deviations in particular (correspondingly small layer thickness tolerances) correlate with small overall thicknesses. Individual examples are adhesive tapes of the invention, more particularly three-layer tapes, which have a thickness of <20 μm with a tolerance of <5 μm, more preferably less than 3 μm, and also those which have a thickness of <10 cm with a tolerance of <3 μm, more preferably <2.5 μm. An especially outstanding product, it has emerged, is a three-layer adhesive tape whose overall thickness is less than 5 μm (carrier film thickness <1 μm, thickness of pressure-sensitive adhesive layers on both sides of the carrier film layer in each case <2 μm) and where the layer thickness tolerance (4s specification limit) has been lowered to <3 μm, in better embodiments to <2.5 μm, and in further improved embodiments to <1 μm.

An exemplary product construction of the PSA tapes of the invention is shown exemplarily by FIG. 2. In that figure (a) designates the carrier film layer and (b) and (b′) designate the layers of adhesive.

Product Construction

The PSA tape of the invention consists of a carrier film layer (a) and two pressure-sensitive adhesive layers (b) and (b′), it being possible for the PSAs to be identical or to differ from one another, in terms not only of their layer thickness but also of their chemical composition.

To enhance the processing properties of the double-sided PSA tape it is furnished, in one very preferred embodiment, with at least one release liner. This allows the double-sided adhesive tape to be unwound and also to be processed further in diecutting operations and also in sheet form. Furthermore, it may be necessary for the double-sided PSA tape to be furnished with two release liners—that is, both sides of adhesive are lined with one or different release liners. This may be very advantageous in the context of the diecutting of these products, more particularly in view of the fact that the diecutting operation imposes heightened requirements in the case of very thin PSA tapes.

The overall thickness of the double-sided PSA tape of the invention is not more than 30 μm (a figure which does not include any release liners that may be present). In one preferred embodiment the layer thickness of the double-sided PSA tape is between 2 and 29 μm, very preferably between 3 and 21 μm.

As a result of the low carrier-film layer thickness the double-sided PSA tape has a very good flexibility, which also allows it to compensate very slight microstructuring on the substrates (e.g. on the reflective film or on the plastic housing) and, as a result of effective wetting behaviour of the adhesive, to achieve a high bonding performance. In spite of this, surprisingly, it has been possible to ensure the necessary stability.

Carrier Film (a)

The carrier film (a) preferably has a layer thickness of 0.5 to 12 μm, more preferably between 0.9 and 8 μm, very preferably between 0.9 and 2 μm.

As film carriers it is possible in principle to use all filmy polymer carriers. Thus it is possible, for example, to use polyethylene, polypropylene, polyether sulphones, polyamides, polyimides, polyetherimides, polyesters, polyphenyl sulphides, polyamideimides, polyetherimides, polymethacrylates, styrene-based films, polycarbonates, polyether ketones, polyaryls, polyurethanes, polyacrylates, polybutyrals, polyethylene-vinyl acetates, polyethylene naphthylates and fluorinated polymers. These types of polymer can be employed alone or in combination with one another. One particularly preferred procedure uses polyester films, with particular preference PET films (polyethylene terephthalate). With a view to the inventively advantageous use, PET films have a high tensile strength and also a very good thickness tolerance. In this context the absolute thickness tolerance is improved more and more by the use of thinner and thinner films.

Films which have been found to be particularly suitable in accordance with the invention are capacitor films, in other words those polymeric films of the kind used for polymeric-film capacitors, which commonly consist of two or more plies of metal foil and polymeric film (“dielectric film”). For use as a carrier film for the PSA tape of the invention, these capacitor films are preferably used in a non-metallized form (for application in capacitors the films are typically metallized, by vapour deposition or sputtering for example). Capacitor films which can be used with particular preference are composed, for example, of polyester.

Suitable films are available, for example, from Mitsubishi Polyester Films under the trade name Hostaphan™. Suitability is possessed more particularly by the grades having the designations RE SMD, RE, TT and RNK.

With a view to the thickness tolerance, the film preferably has a maximum deviation of 0.5 μm (specification limit 4s), most preferably of 0.2 μm.

The carrier advantageously possesses a single-layer construction, but may also be constructed of a plurality of layers.

The carrier thickness (a) is below the overall thickness of the double-sided adhesive tape, in order to allow it to be furnished on both sides with the pressure-sensitive adhesive (b) or (b′). The thickness of the adhesive tape is a product of the thickness of the carrier layer, of the two PSA layers and, where appropriate, of further layers present optionally. In one preferred embodiment, more particularly in the case of three-layer adhesive tapes, the difference between the layer thickness of the carrier (a) and the sum of the layer thicknesses of the PSAs (b) and (b′) is not more than 29 μm, very preferably less than 20 μm, most preferably less than 15 μm.

The thickness of the layers of adhesive influences the bond strength of the double-sided adhesive tape. Advantageously the approach taken is such that the adhesive tape has a bond strength sufficient for the particular end use, more particularly for application in electronic components in the manner set out in this specification. For this purpose it is very advantageous if the layers of adhesive are in each case at least 0.5 μm thick, preferably each 1 μm thick.

The carrier films (a) may have been detensioned or may have one or more preferential directions. Preferential directions are obtained by drawing in one direction, in two directions or else in two or more directions, more particularly directions situated within the plane of the film, an approach which can be taken more particularly in the case of two draws being that where the draw directions are selected at a right angle to one another. The detensioned form is preferred for the inventive application, since in general, in the course of the coating operations and also in the final application, it is no longer possible for there to be any dimensional change in the carrier film in the event of possible subsequent climatic changes.

Advantageously, anti-blocking agents, such as silicon dioxide, siliceous or other chalk, zeolites or the like, for example, are added to the films in the production operation [as for example in the production of polyethylene terephthalate films (PET films)].

For the inventive PSA tapes it is possible with great preference to use films of minimal roughness. These films preferably include little anti-blocking agent, in other words have a low anti-blocking agent content.

Furthermore it may be advantageous for the invention to colour or pretreat the carrier film (a). Coloration may be desirable, for example, in order to improve the detection characteristics in the diecutting operation after actual diecutting has taken place (especially advantageous in the case of very thin films). For this purpose the carrier film may have been coloured by the ‘masterbatch’ process itself (e.g. the PET already includes the colour pigments prior to film extrusion), or may be given a varnish coating or a coloured primer. It may also be of advantage, furthermore, for the carrier film (a) to be pretreated in order to improve the anchoring of the PSAs (b) and (b′) on the carrier film. For the pretreatment it is possible to employ physical and/or chemical methods. Suitable examples, then, are plasma, corona and/or flame pretreatments, the application of adhesion promoters (primers) and/or chemical etching processes

PSAs (b) and (b′)

The PSAs (b) and (b′) are advantageously identical on both sides of the PSA tape. Alternatively, depending on application, it may be of advantage for the PSAs (b) and (b′) to differ from one another, more particularly in their layer thicknesses and/or their chemical compositions. In this way it is possible, for example, to set different adhesion properties. PSA systems used with particular preference for the inventive double-sided PSA tape are acrylate adhesives, natural rubber adhesives, synthetic rubber adhesives, silicone adhesives or EVA adhesives.

It is also possible in principle, however, to process all of the other PSAs that are known to the person skilled in the art [with regard to the state of the art cf. for example the “Handbook of Pressure Sensitive Adhesive Technology” by Donatas Satas (van Nostrand, N.Y. 1989)].

For natural-rubber adhesives the natural rubber is milled to a molecular weight (weight average) of not below about 100 000 daltons, preferably not below 500 000 daltons, and additized.

In the case of rubber/synthetic rubber as starting material for the adhesive, there are wide possibilities for variation. Use may be made of natural rubbers or of synthetic rubbers, or of any desired blends of natural rubbers and/or synthetic rubbers, it being possible for the natural rubber or natural rubbers to be chosen in principle from all available grades, such as, for example, crepe, RSS, ADS, TSR or CV types, in accordance with the purity level and viscosity level required, and for the synthetic rubber or synthetic rubbers to be chosen from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

With further preference it is possible, in order to improve the processing properties of the rubbers, to add to them thermoplastic elastomers with a weight fraction of 10% to 50% by weight, based on the overall elastomer fraction. As representatives, mention may be made at this point, in particular, of the particularly compatible styrene-isoprene-styrene (SIS) and styrene-butadiene-styrene (SBS) types.

In one inventively preferred procedure use is made of (meth)acrylate PSAs (a term which for the purposes of this specification embraces PSAs based on polyacrylates and/or polymethacrylates).

(Meth)acrylate PSAs, which are obtainable by free-radical addition polymerization, preferably consist to the extent of at least 50% by weight of at least one acrylic monomer from the group of the compounds of the following general formula:

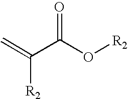

In this formula R₁ is H or CH₃ and the radical R₂ is H or CH₃ or is selected from the group of the branched or unbranched, saturated alkyl groups having 1 to 30 carbon atoms.

The monomers are preferably chosen such that the resulting polymers can be used, at room temperature or higher temperatures, as PSAs. For use as PSAs, the fractions of the corresponding monomers are selected such that the polymerization product more particularly has a glass transition temperature (T_{g})≦15° C. The monomers are preferably selected such that the resulting polymers can be used at room temperature as PSAs, more particularly such that the resulting polymers possess pressure-sensitive adhesive properties in accordance with the “Handbook of Pressure Sensitive Adhesive Technology” by Donatas Satas (van Nostrand, N.Y., 1989, pages 444-514). The glass transition temperature of the polymers forming the basis for the PSAs is advantageously below 15° C. in the sense of a dynamic glass transition temperature for amorphous systems, and the melting temperature for semi-crystalline systems, which can be determined by means of dynamic-mechanical analysis (DMA) at low frequencies.

In a further inventive embodiment the comonomer composition is chosen such that the PSAs can be used as heat-activable PSAs. For the application of a heat-activable PSA (or of a hotmelt adhesive), in other words of a material which becomes tacky only on heating, the fractions of the monomers are selected more particularly such that the copolymer has a glass transition temperature (T_{g}) between 15° C. and 100° C., preferably between 30° C. and 80° C., more preferably between 40° C. and 60° C., in the sense of dynamic glass transition temperatures for amorphous systems, and melting temperatures for semi-crystalline systems, which can be determined by dynamic-mechanical analysis (DMA) at low frequencies.

The polymers can be obtained preferably by polymerizing a monomer mixture which is composed of acrylic esters and/or methacrylic esters and/or the free acids thereof, with the formula CH₂═C(R₁)(COOR₂), where R₁ is H or CH₃ and R₂ is an alkyl chain having 1-20 C atoms or is H.

The molar masses M_{W} of the polyacrylates used amount preferably to M_{W}≧200 000 g/mol (determined by means of gel permeation chromatography; cf. experimental section).

In one way which is greatly preferred, acrylic or methacrylic monomers are used which are composed of acrylic and methacrylic esters having alkyl groups comprising 4 to 14 C atoms, and preferably comprise 4 to 9 C atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and the branched isomers thereof, such as isobutyl acrylate, 2-ethyl-hexyl acrylate, 2-ethylhexyl methacrylate, isooctyl acrylate, and isooctyl methacrylate, for example.

Further classes of compound which can be used are monofunctional acrylates and/or methacrylates of bridged cycloalkyl alcohols consisting of at least 6 C atoms. The cycloalkyl alcohols can also be substituted, by C-1-6 alkyl groups, halogen atoms or cyano groups, for example. Specific examples are cyclohexyl methacrylates, isobornyl acrylate, isobornyl methacrylates, and 3,5-dimethyladamantyl acrylate.

In one procedure monomers are used which carry polar groups such as carboxyl radicals, sulphonic and phosphonic acid, hydroxyl radicals, lactam and lactone, N-substituted amide, N-substituted amine, or carbamate, epoxy, thiol, alkoxy or cyano radicals, ether or the like.

Moderate basic monomers are, for example, N,N-dialkyl-substituted amides, such as, for example, N,N-dimethylmethaacrylamide, N,N-dimethylmethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, and N-isopropylacrylamide, this enumeration not being exhaustive.

Further preferred examples are hydroxyethyl acrylate, hydroxypropyl acrylate, hydroxyethyl methacrylate, hydroxypropyl methacrylate, allyl alcohol, maleic anhydride, itaconic anhydride, itaconic acid, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, 13 -acryloyloxypropionic acid, trichloroacrylic acid, fumaric acid, crotonic acid, aconitic acid, and dimethylacrylic acid, this enumeration not being exhaustive.

In one further very preferred procedure use is made as monomers of vinyl esters, vinyl ethers, vinyl halides, vinylidene halides, and vinyl compounds having aromatic rings and heterocycles in α-position. Here again, mention may be made, non-exclusively, of some examples: vinyl acetate, vinylformamide, vinylpyridine, ethyl vinyl ether, vinyl chloride, vinylidene chloride, and acrylonitrile.

Moreover, in one further procedure, use is made of photoinitiators having a copolymerizable double bond. Suitable photoinitiators include Norrish I (α-cleaving, photofragmenting) and Norrish II (intramolecularly hydrogen-abstracting) photoinitiators. Examples include benzoin acrylate and acrylated benzophenones, such as one from UCB (Ebecryl P 36®). In principle it is possible to copolymerize any photoinitiators which are known to the skilled worker and which are able to crosslink the polymer by way of a free-radical mechanism under UV irradiation. An overview of possible photoinitiators which can be used and can be functionalized with a double bond is given in Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London is used as a supplement.

In another preferred procedure the comonomers described are admixed with monomers which possess a high static glass transition temperature. Suitable components include aromatic vinyl compounds, an example being styrene, in which the aromatic nuclei consist preferably of C₄ to C₁₈ units and may also include heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, t-butylphenyl acrylate, t-butylphenyl methacrylate, 4-biphenylyl acrylate, 4-biphenylyl methacrylate, 2-naphthyl acrylate, 2-naphthyl methacrylate, and mixtures of these monomers, this enumeration not being exhaustive.

For further development it is possible to admix resins to the PSAs. As tackifying resins for addition it is possible without exception to use all tackifier resins previously known and described in the literature. Representatives that may be mentioned include the pinene resins, indene resins, and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking it is possible to employ any resins which are compatible (soluble) with the polyacrylate in question: in particular, reference may be made to all aliphatic, aromatic and alkylaromatic hydrocarbon resins, hydrocarbon resins based on pure monomers, hydrogenated hydrocarbon resins, functional hydrocarbon resins, and natural resins. Reference is expressly made to the presentation of the state of knowledge in the “Handbook of Pressure Sensitive Adhesive Technology” by Donatas Satas (van Nostrand, 1989).

Here as well, the transparency is improved using, preferably, transparent resins which are highly compatible with the polymer. Hydrogenated or partly hydrogenated resins frequently feature these properties.

In addition it is possible, optionally, for plasticizers, further fillers (such as, for example, fibres, carbon black, zinc oxide, chalk, solid or hollow glass beads, microbeads made of other materials, silica, silicates), nucleators, electrically conductive materials, such as, for example, conjugated polymers, doped conjugated polymers, metal pigments, metal particles, metal salts, graphite, etc., expandants, compounding agents and/or ageing inhibitors, in the form of, for example, primary and secondary antioxidants or in the form of light stabilizers, to have been added.

In addition it is possible to admix crosslinkers and promoters for crosslinking. Examples of suitable crosslinkers for electron beam crosslinking and UV crosslinking include difunctional or polyfunctional acrylates, difunctional or polyfunctional isocyanates (including those in blocked form), and difunctional or polyfunctional epoxides. In addition it is also possible for thermally activable crosslinkers to have been added, such as Lewis acid, metal chelates or polyfunctional isocyanates, for example.

For optional crosslinking with UV light it is possible to add UV-absorbing photoinitiators to the PSAs. Useful photoinitiators whose use is very effective are benzoin ethers, such as benzoin methyl ether and benzoin isopropyl ether, substituted acetophenones, such as 2,2-diethoxyacetophenone (available as Irgacure 651® from Ciba Geigy®), 2,2-dimethoxy-2-phenyl-1-phenylethanone, dimethoxyhydroxyacetophenone, substituted α-ketols, such as 2-methoxy-2-hydroxypropiophenone, aromatic sulphonyl chlorides, such as 2-naphthylsulphonyl chloride, and photoactive oximes, such as 1-phenyl-1,2-propanedione 2-(O-ethoxycarbonyl)oxime, for example.

The abovementioned photoinitiators and others which can be used may preferably contain the following radicals: benzophenone, acetophenone, benzil, benzoin, hydroxyalkylphenone, phenyl cyclohexyl ketone, anthraquinone, trimethylbenzoylphosphine oxide, methylthiophenylmorpholine ketone, aminoketone, azobenzoin, thioxanthone, hexaarylbisimidazole, triazine, or fluorenone, it being possible for each of these radicals to be additionally substituted by one or more halogen atoms and/or by one or more alkyloxy groups and/or by one or more amino groups or hydroxy groups. A representative overview is given by Fouassier: “Photoinitiation, Photopolymerization and Photocuring: Fundamentals and Applications”, Hanser-Verlag, Munich 1995. Carroy et al. in “Chemistry and Technology of UV and EB Formulation for Coatings, Inks and Paints”, Oldring (Ed.), 1994, SITA, London can be used as a supplement.

Production Processes for the Acrylate PSAs

The nature of the polyacrylate under preparation (PSA; heat-sealing compound and the like) can be influenced more particularly by varying the glass transition temperature of the polymer, by means of different weight fractions of the individual monomers.

For purely crystalline systems at the melting point Tₘ there is a thermal equilibrium between crystal and liquid. Amorphous or partly crystalline systems, in contrast, are characterized by the transformation of the more or less hard amorphous or partly crystalline phase into a softer (rubberlike to high-viscosity) phase. At the glass transition point, particularly in the case of polymeric systems, there is a “thawing” (or “freezing” on cooling) of the Brownian molecular motion of relatively long chain segments.

The transition from the melting point Tₘ (also “melting temperature”; actually defined only for purely crystalline systems; “polymer crystals”) to the glass transition point T_{g} (also “glass transition temperature”) can therefore be considered to be a fluid one, depending on the proportion of partial crystallinity in the sample under analysis.

For the purposes of this specification, in the sense of the remarks above, a reference to the glass transition point also includes the melting point: in other words, for the corresponding “melting” systems, the melting point is also understood as the glass transition point (or else, synonymously, as the glass transition temperature). The reporting of the glass transition temperatures is based on the determination by means of dynamic-mechanical analysis (DMA) at low frequencies.

In order to obtain polymers, such as PSAs or heat-sealing compounds, for example, which have desired glass transition temperatures, the quantitative composition of the monomer mixture is advantageously selected in such a way as to result in the desired T_{g} for the polymer in accordance with an equation (E1) analogous to the Fox equation (cf. T. G. Fox, Bull. Am. Phys. Soc. 1 (1956) 123).

$$\frac{1}{{T}_{g}} = {\sum }_{n} \frac{{w}_{n}}{{T}_{g , n}} \qquad ( E 1 )$$

In this equation, n represents the serial number of the monomers used, wₙ the mass fraction of the respective monomer n (% by weight), and T_{g,n} the respective glass transition temperature of the homopolymer of the respective monomer n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centred radicals is described in Houben Weyl, Methoden der Organischen Chemie, Vol. E 19a, pp. 60-147, for example. These methods are employed, preferentially, in analogy.

Examples of free-radical sources are peroxides, hydroperoxides, and azo compounds; some nonlimiting examples of typical free-radical initiators that may be mentioned here include potassium peroxodisulphate, dibenzoyl peroxide, cumene hydroperoxide, cyclohexanone peroxide, di-t-butyl peroxide, azodiisobutyronitrile, cyclohexylsulphonyl acetyl peroxide, diisopropyl percarbonate, t-butyl peroctoate, and benzpinacol. In one very preferred version the free-radical initiator used is 1,1′-azobis(cyclohexane-carbonitrile) (Vazo 88™ from DuPont) or azodiisobutyronitrile (AIBN).

The average molecular weights M_{W} of the PSAs formed in the free-radical polymerization are very preferably chosen such that they are situated within a range of 200 000 to 4 000 000 g/mol; specifically for the further inventive uses, PSAs are prepared which have average molecular weights M_{W} of 400 000 to 1 400 000 g/mol. The molar mass distributions may also be bimodal or multimodal. The average molecular weight is determined by size exclusion chromatography (GPC; cf. experimental section).

The polymerization may be conducted without solvent, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulphides, sulphoxides, sulphones, alcohol derivatives, hydroxy ether derivatives, amino alcohols, ketones and the like, and also derivatives and mixtures thereof.

The polymerization time—depending on conversion and temperature—is preferably between 2 and 72 hours. The higher the reaction temperature which can be chosen, i.e., the higher the thermal stability of the reaction mixture, the shorter the chosen reaction time can be.

As regards initiation of the polymerization, the introduction of heat is essential for thermally decomposing initiators. For the thermally decomposing initiators the polymerization can be initiated by heating to from 50 to 160° C., depending on initiator type.

For the preparation it can also be of advantage to polymerize the (meth)acrylate PSAs without solvent. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such us aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminium compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

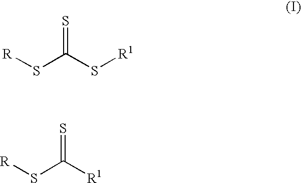

in which R and R¹ are chosen independently of one another or identical, and are selected from the group of the following substituents; comprising
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one oxygen atom and/or one NR* group in the carbon chain, R* being any radical (particularly an organic radical);
C₃-C₁₈ aikynyl radicals, C₃-C₁₈ alkenyl radicals, C₁-C₁₈ alkyl radicals substituted by at least one ester group, amine group, carbonate group, cyano group, isocyano group and/or epoxy group and/or by sulphur;
C₃-C₁₂ cycloalkyl radicals;
C₆-C₁₈ aryl or benzyl radicals;
hydrogen.

Control reagents of type (I) are preferably composed of the following further-restricted compounds:

Halogen atoms therein are preferably F, Cl, Br or I, more preferably Cl and Br. Outstandingly suitable alkyl, alkenyl and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyls having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one oxygen atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethylphenyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

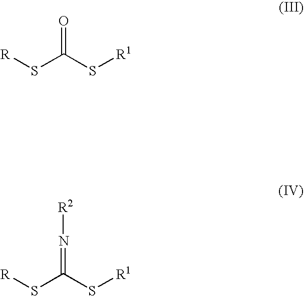

where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hotmelt PSAs, since the high fraction of residual monomers adversely affects the technical adhesive properties; the residual monomers contaminate the solvent recyclate in the concentration operation; and the corresponding self-adhesive tapes would exhibit very high outgassing behaviour. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favourable procedure, use is made of nitroxides of type (Va) or (Vb):

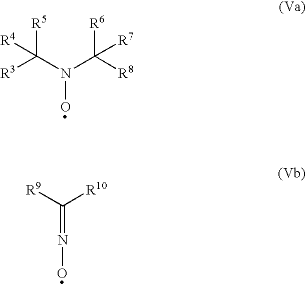

where R³, R⁴, R⁵, R⁶, R⁷, R⁸, R⁹, and R¹⁰ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂, where R¹¹, R¹² or R¹³ stand for radicals from group ii).

Compounds of the formula (Va) or (Vb) can also be attached to polymer chains of any kind (primarily such that at least one of the abovementioned radicals constitutes a polymer chain of this kind) and may therefore be used for the synthesis of polyacrylate PSAs.

Selected with greater preference are controlled polymerization regulators of the type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-anninomethyl-PROXYL, 3-methoxy-PROXYL, 3-t-butyl-PROXYL, 3,4-di-t-butyl-PROXYL
2,2,6,6-tetramethyl-1-piperidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-tert-butyl nitroxide
diphenyl nitroxide
tert-butyl tert-amyl nitroxide.

A series of further polymerization methods in accordance with which the PSAs can be prepared by an alternative procedure can be chosen from the prior art:

U.S. Pat. No. 4,581,429 A discloses a controlled-growth free-radical polymerization process which uses as its initiator a compound of the formula R′R″N—O—Y, in which Y is a free-radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates.

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

Release Liner

The double-sided PSA tape may be furnished on one or both sides with a release liner. The release liner or liners prevent the PSAs (b) and (b′) sticking to one another when the adhesive tape is wound. For the inventive use of the double-sided PSA tapes the release liners ought to be as smooth as possible. Thus it is possible to use release liners based on polymeric films, papers, woven materials and/or metal foils. Examples of papers which can be used include glassine papers or “clay-coated” (kaolin-coated) papers. The thickness of the base material is preferably between 10 and 500 μm, depending on the subsequent processing technique.

In one very preferred embodiment the base materials used for the release liners are polymeric films. These may be based, for example, on polyethylene, polypropylene, polyether sulphones, polyamides, polyimides, polyetherimides, polyesters, polyphenyl sulphides, polyamideimides, polyetherimides, polymethacrylates, styrene-based films, polycarbonates, polyether ketones, polyaryls, polyurethanes, polyacrylates, polybutyrals, polyethylene-vinyl acetates or polyethylene naphthylates. The polymeric films may be detensioned or monoaxially or biaxially oriented.

Particular preference, with a view to the manufacture of the double-sided PSA tape, is given to polyester films based on polyethylene terephthalate (PET).

For the release function the base substrates are furnished with at least one release coat. The release coat is based preferably on silicones, fluorinated silicones or fluorinated polymers. Compounds based on long aliphatic chains can be used as the release coat.

Coating Processes, Treatment of the Carrier Material

For the production of the double-sided PSA tapes in one preferred embodiment the PSA is coated from solution onto the carrier material. In principle the adhesive can also be applied from the melt, although this results in higher thickness tolerances for the adhesive tape.

For coating from the melt it may be necessary, for the production process, to remove the solvent from the PSA. In this case it is possible in principle to use any of the techniques known to a person skilled in the art. One very preferred technique is that of concentration using a single-screw or twin-screw extruder. The twin-screw extruder can be operated corotatingly or counter-rotatingly. The solvent or water is preferably distilled off over two or more vacuum stages. Counterheating is also carried out depending on the distillation temperature of the solvent. The residual solvent fractions amount to preferably <1%, more preferably <0.5% and very preferably <0.2%. Further processing of the hotmelt takes place from the melt.

For coating as a hotmelt it is possible to employ different coating processes. In one version the PSAs are coated by a roll coating process. Different roll coating processes are described in the “Handbook of Pressure Sensitive Adhesive Technology”, by Donatas Satas (van Nostrand, N.Y. 1989). In another version, coating takes place via a melt die. In a further preferred process, coating is carried out by extrusion. Extrusion coating is performed preferably using an extrusion die. The extrusion dies used may come advantageously from one of the three following categories: T-dies, fishtail dies and coathanger dies. The individual types differ in the design of their flow channel. Through the coating it is also possible for the PSAs to undergo orientation.

In addition it may be necessary for the PSA to be crosslinked. In one preferred version, crosslinking takes place with electron beams and/or UV radiation.

UV crosslinking irradiation is carried out with shortwave ultraviolet irradiation in a wavelength range from 200 to 400 nm, depending on the UV photoinitiator used; in particular, irradiation is carried out using high-pressure or medium-pressure mercury lamps at an output of 80 to 240 W/cm. The irradiation intensity is adapted to the respective quantum yield of the UV photoinitiator and the degree of crosslinking that is to be set.

Furthermore, in one embodiment, the PSAs can be crosslinked using electron beams. Typical irradiation equipment which can be employed includes linear cathode systems, scanner systems, and segmented cathode systems, where electron beam accelerators are employed. A detailed description of the state of the art and the most important process parameters are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably 80 kV and 300 kV. The scatter doses employed range between 5 to 150 kGy, in particular between 20 and 100 kGy.

It is also possible to employ both crosslinking processes, or other processes allowing high-energy irradiation.

In one very preferred version the adhesive is coated from solution. In this case it is possible to employ very different coating processes. Coating here may also take place from the die, or by a blade coater or by spray coating or by roll applicators or by printing. Particularly suitable for very thin coatings are the spray coating process or the roll application process. By means of a relatively high dilution with the solvent, the thickness tolerance of the coating is improved, since the solvent is evaporated subsequently. In this way the thickness tolerance for a particular coating assembly is determined by the mechanics. Where coating takes place from solution, these mechanics produce a defined tolerance for the PSA film coated from solution, but one which is subsequently reduced yet again by the loss of the solvent by evaporation.

After the coating of the solvent-borne PSA, the solvent is removed. This is done with particular preference in a drying tunnel having a very long residence time. Typically, heating is carried out to high levels in different temperature stages, in order to prevent the formation of bubbles. Moreover, the final drying temperature should be above the boiling point of the solvent, in order to minimize the subsequent outgassing of the double-sided PSA tape.

In the first step the PSA is coated onto the release liner. This takes place preferably from a very dilute solution. In one preferred embodiment the solids content of the solution is less than 25%, very preferably less than 15%, based in each case on the fraction of the PSA in the solvent. Coating may take place, for coatweights of 4-10 g/m² (solids—after drying), by the blade process. For very low coatweights of 1-3 g/m², it is preferred to use the spray coating process or a 5-roll applicator. The use of very low solids contents (less than 15% solids content) allows the layer thickness tolerance for the coating of the PSA tape film to be lowered.

Through the use of a five-roll applicator it is possible to achieve a layer thickness tolerance, for a coatweight, for example, of 1 g/m² (solids—after drying), of ±30%, which corresponds in absolute terms to a fluctuation of 0.3 g/m².

After the first coating step of the PSA, the adhesive is dried in a drying tunnel and removed from the solvent. The heat introduced may additionally be utilized to initiate a thermal crosslinking reaction. It may further be necessary to crosslink the composition using UV and/or electron beams. For this purpose it is possible to employ the technologies already stated in the hotmelt process.

After the coating and drying of the pressure-sensitive adhesive, the carrier film is laminated onto the adhesive. For this purpose it may be necessary to pretreat the carrier film by—for example—corona. Lamination ought to take place without bubbles. It should also be ensured that the tensile stresses—particularly in the case of the very thin versions of the carrier film—are selected well below the breaking tension of the carrier film. The tensile stress in one preferred embodiment is at least 50% below the breaking tension of the carrier film.

In order to produce the double-sided PSA tape it is also necessary, moreover, to apply the second PSA layer. This can take place with the processes already stated above. In principle the PSA in the second coat can be coated directly onto the carrier film (assembly formed from release liner, PSA layer and carrier film). This, however, is not a preferred embodiment, since in this case stresses in the downstream drying tunnel may occur as a result of the introduction of heat. A very much preferred variant encompasses the step of first coating the second PSA onto a release liner and then drying it in the drying tunnel, before laminating it with the assembly formed from release liner, PSA and carrier film, on the carrier film side. This makes it possible to spare the carrier film the thermal load, which is advantageous for a carrier film of less than 4 μm in layer thickness, more preferably of below 2 μm in layer thickness.

In this operating step as well it may be necessary additionally to crosslink the PSA layer with UV and/or electron beams, in accordance with the processes identified above.

In a very much preferred variant, the double-sided PSA tape is used, in the assembly described, as a double-liner product. The double-liner version allows air inclusions (fish eyes) and bubbles to be avoided, which would otherwise adversely affect the thickness tolerance of the product and would lead to unevennesses in the context of the inventive use, with regard to the reflection behaviour. It may also be of advantage, however, to delaminate a release liner and to use it again for the same or another operation. This step, however, ought then likewise not to lead to any inclusion of air bubbles or fish eyes when the PSA tape is wound.

In one preferred way of the invention the thickness tolerance of the double-sided PSA tape, obtained in accordance with the process described above, is less than 6 μm, more preferably less than 3 μm, most preferably less than 1 μm. The limit values take account of the overall thickness of the double-sided PSA tape. Hence 6 μm is a preferred thickness tolerance for 20-29 μm double-sided PSA tapes, 3 μm a preferred thickness tolerance for 10-19 μm double-sided PSA tapes, and 1 μm a preferred thickness tolerance for 3-9 μm double-sided PSA tapes.

Inventive Use

The invention further provides for the use of the double-sided PSA tape for bonding the reflective film in the housing of the backlighting unit. For the use of the PSA tape the double-sided PSA tapes can be lined with one or two release films or release papers. In a first step, punched products (diecuts) are produced, for which it is possible here to employ the typical flat-bed, rotational or laser diecutting processes. In one very preferred embodiment the double-sided PSA tape is first laminated onto the reflective film over the full area. For this purpose it may be necessary to remove the release liner prior to the laminating step. The lamination of the reflective film must take place without including bubbles or impurities, so as to avoid unevennesses.

The reflective film may be a metallized film which has been vapour-coated, for example, on one or both sides with aluminium or silver. To increase the climatic resistance it may also be advantageous to provide the reflective layer with a transparent protective varnish. In order to achieve particularly outstanding reflection properties it is necessary to control the sputtering operation for vapour-coating in such a way that the aluminium or silver is applied very uniformly. The reflective film preferably has an overall thickness of between 10 and 100 μm, and may also feature embossing.

After the full or partial bonding of the double-sided PSA tape to the reflective film, the film is brought into the desired shape in a diecutting process.

For this purpose it is possible to employ the processes identified above.

Subsequently the release liner is removed from the assembly comprising reflective film and double-sided PSA tape, and the assembly is then located in the housing of the backlighting unit. This housing may be made of plastic or metal. With great preference, use is made of plastics such as polycarbonate, for example.

Application again takes place advantageously without air inclusions. As well as the holding strength of the reflective film in the housing, a further decisive criterion is the resistance to climatic cycling. Thus, after bonding, there should be no lifting of the reflective film iii the climatic cycling test. Climatic cycling tests encompass on the one hand a constant climate at elevated temperatures and atmospheric humidity, and on the other hand a cycle between low temperatures and high temperatures in a defined rhythm. Advantageously there ought to be no lifting in a constant climate at 85° C. and 85% humidity (relative atmospheric humidity) in the course of measurements spanning 500 and 1000 hours. Furthermore, after bonding and storage in a climate cycle of −40° C. and +85° C. (ramp from −40° C. to +85° C.: 1 hour), with 4 cycles every 24 hours, there ought likewise to be no lifting in the course of a total storage time of 500 and 1000 hours.

Experimental Section

Gel Permeation Chromatography GPC:

The figures given for the weight-average molecular weight M_{W} and the polydispersity PD in this specification refer to a determination by gel permeation chromatography. The determination is made on a 100 μl sample which has been subjected to clarifying filtration (sample concentration 4 g/l). The eluent used is tetrahydrofuran containing 0.1% by volume of trifluoroacetic acid. Measurement is made at 25° C. The pre-column used is a PSS-SDV column, 5μ, 10³ Å, ID 8.0 mm×50 mm. Separation is carried out using columns of type PSS-SDV, 5μ, 10³ Å and also 10⁵Å and 10⁶ Å each with an ID 8.0 mm×300 mm (columns from Polymer Standards Service; detection by means of Shodex RI71 differential refractometer). The flow rate is 1.0 ml per minute. Calibration is made against PMMA standards (polymethyl methacrylate calibration).

Measurement of the Overall Thickness of the Adhesive Tapes and of the Layer Thickness of the Carrier Film Layers

The reporting of the thicknesses of adhesive tapes and film carriers refers to the measurement according to ASTM D 1000-04 (1 Sep. 2004), No. 21 to 27, with the following parameters: disc diameter 10 mm (No. 23.1.2.); applied pressure 4 N (No. 23.1.3.); test conditions: temperature 23° C., 50% atmospheric humidity; the evaluation was made within an hour; measurement took place at distances of 10 cm in cross direction to the running adhesive tape.

(As an alternative method of determination it is possible to employ, accordingly, AFERA 4000/PSTC 33, with the above parameters.)

Standard deviation s given by

$$s = \sqrt{\frac{1}{n} \cdot {\sum }_{i = 1}^{n} {( {x}_{i} - \overline{x} )}^{2}}$$

where n is the number of data values, xᵢ: indicates the individual measurement values, and x̅: denotes the average of all the measurement values.

### EXAMPLES

The invention is described below, without wishing the choice of the examples to imply any unnecessary restriction.

The test methods employed were as follows.

Test Methods

A. Reflectance

The reflectance test is carried out in accordance with DIN standard 5063 Part 3. The instrument used was a type LMT Ulbrecht sphere. The reflectance is reported as the sum of directed and scattered light fractions, in %.

B. Climatic Test 85% Atmospheric Humidity and 85° C.

In a climate chamber the bonded component is stored. The climate chamber is operated at a temperature of 85° C. and at 85% atmospheric humidity (relative humidity). The bonded components are removed in each case after storage times of 500 and 1000 hours, and examined for instances of lifting. The test is passed when there is no lifting apparent.

C. Climatic Cycling Test −40° C./85° C.

In a cycling climate chamber the bonded component is stored. The climate chamber is started at a temperature of 23° C. and at 50% atmospheric humidity (relative humidity). First of all, heating takes place over the course of 30 minutes to 85° C./50% humidity. This temperature is maintained for 5 hours. Subsequently, over the course of one hour, cooling takes place to −40° C./0% humidity. This temperature is again maintained for 5 hours. Then heating is carried out again, over the course of one hour, to 85° C./50% humidity, and this temperature level is held for 5 hours. This cycle is then run constantly. The bonded components are removed in each case after total storage times of 500 and 1000 hours, and examined for instances of lifting. The test is passed when there is no lifting apparent.

180° Bond Strength Test (Test D)

The double-sided PSA tape is lined with a PVC film 40 μm thick. The PSA strip was pressed onto polycarbonate twice using a 2 kg weight. Immediately thereafter the adhesive tape was peeled from the substrate at a speed of 300 mm/min and at an angle of 180°. The results of the measurement are reported in N/cm and have been averaged from three measurements. All measurements were conducted at room temperature under climatized conditions (23° C./50% atmospheric humidity).

Polymer 1

A 200 I reactor conventional for free-radical polymerizations was charged with 2400 g of acrylic acid, 64 kg of 2-ethylhexyl acrylate, 6.4 kg of N-isopropylacrylamide and 53.3 kg of acetone/isopropanol (95:5). After nitrogen gas had been passed through the reactor for 45 minutes with stirring, the reactor was heated to 58° C. and 40 g of 2,2′-azoisobutyronitrile (AIBN) were added. Subsequently the external heating bath was heated to 75° C. and the reaction was carried out constantly at this external temperature. After a reaction time of 1 h a further 40 g of AIBN were added. After 5 h and 10 h, dilution was carried out with 15 kg each time of acetone/isopropanol (95:5). After 6 h and 8 h, 100 g each time of dicyclohexyl peroxydicarbonate (Perkadox 16®, Akzo Nobel), in solution in each case in 800 g of acetone, were added. The reaction was discontinued after a reaction time of 24 h, and the reaction mixture was cooled to room temperature. Subsequently 30 per cent by weight of a rosin (Foral 85, softening temperature 85° C., manufacturer: Hercules) was added, and 0.5 per cent by weight of aluminium(III) acetylacetonate was stirred in homogeneously. The PSA was diluted to a solids content of 15% with toluene.

Production of the Double-Sided PSA Tapes

For the production of the double-sided PSA tapes, polyethylene terephthalate films from Mitsubishi Polyester Films are selected. The films possess layer thicknesses of 0.9 μm, 2 μm and 4 μm, and are available under the trade name Hostaphan™ RE.

These are biaxially oriented and heat-set PET films of high purity which were developed for capacitor applications. The arithmetic mid-point roughness (Ra value; average value of the absolute values (without sign) of the modified roughness profile, based on the middle line over the reference section L) is about 10 nm lower than that of standard films of corresponding thickness.

Guideline Values (According to Manufacturer):

Mechanical values (ISO 527-1-2; test speed 100%/min; 23° C., 50% relative humidity): tensile strength along 200 N/mm²; across 200 N/mm²; breaking extension along 100%; across 100%; elasticity modulus along 4500 N/mm²; across 5000 N/mm²

Density (ASTM-D 1505-68, method C; 23° C.): 1.395 g/cm²

Contraction (DIN 40634, 150° C., 15 min): along <2.5%; across <2%

Melting point (differential thermoanalysis; 3 K/min): 260° C.

### Example 1

The PSA, ‘polymer 1’, is coated from solution onto a siliconized PET film (75 μm layer thickness, manufacturer Siliconature, silicone system graded with 10% CRA™). Coating is carried out using a five-roll applicator mechanism with roll sag compensation. The coated PSA film is subsequently dried in a 40 m drying tunnel with temperature stages of 30° C./40° C./50° C./70° C./100° C. and 110° C. The web speed is 20 m/min. The coatweight after drying was 1.2 g/m². In a subsequent step a 0.9 μm PET film from Mitsubishi is laminated on.

In a second production run, ‘polymer 1’ is again coated from solution onto a siliconized PET film (75 μm layer thickness, manufacturer: Siliconature, easy release). Coating is carried out using a five-roll applicator mechanism with roll sag compensation. The coated PSA film is subsequently dried in a 40 m drying tunnel with temperature stages of 30° C./40° C./50° C./70° C./100° C. and 110° C. The web speed is 20 m/min. The coatweight after drying was 1.2 g/m². Subsequently the PSA was laminated onto the first assembly comprising PET film/PSA/PET release liner. The overall thickness of the PSA tape was 3 μm (without taking account of the PET release liners). The measurement of the tolerances (over a width of 50 cm/5 samples) gave a maximum deviation (4s) of 1 μm.

### Example 2

The PSA, ‘polymer 1’, is coated from solution onto a siliconized PET film (75 μm layer thickness, manufacturer Siliconature, silicone system graded with 10% CRA™). Coating is carried out using a comma bar with sag compensation. The coated PSA film is subsequently dried in a 40 m drying tunnel with temperature stages of 30° C./40° C./50° C./70° C./100° C. and 110° C. The web speed is 20 m/min. The coatweight after drying was 5.5 g/m². In a subsequent step a 0.9 μm PET film from Mitsubishi is laminated on.

In a second production run, ‘polymer 1’ is again coated from solution onto a siliconized PET film (75 μm layer thickness, manufacturer: Siliconature, easy release). Coating is carried out using a comma bar with sag compensation. The coated PSA film is subsequently dried in a 40 m drying tunnel with temperature stages of 30° C./40° C./50° C./70° C./100° C. and 110° C. The web speed is 20 m/min. The coatweight after drying was 5.5 g/m². Subsequently the PSA was laminated onto the first assembly comprising PET film/PSA/PET release liner. The overall thickness of the PSA tape was 10 μm (without taking account of the PET release liners). The measurement of the tolerances (over a width of 50 cm/5 samples) gave a maximum deviation (4s) of 2.5 μm.

### Example 3

The PSA, ‘polymer 1’, is coated from solution onto a siliconized PET film (75 μm layer thickness, manufacturer Siliconature, silicone system graded with 10% CRA™). Coating is carried out using a comma bar with sag compensation. The coated PSA film is subsequent!” dried in a 40 m drying tunnel with temperature stages of 30° C./40° C./50° C./70° C./100° C. and 110° C. The web speed is 20 m/min. The coatweight after drying was 4.5 g/m². In a subsequent step a 2 μm PET film from Mitsubishi is laminated on.

In a second production run, ‘polymer 1’ is again coated from solution onto a siliconized PET film (75 μm layer thickness, manufacturer: Siliconature, easy release). Coating is carried out using a comma bar with sag compensation. The coated PSA film is subsequently dried in a 40 m drying tunnel with temperature stages of 30° C./40° C./50° C./70° C./100° C. and 110° C. The web speed is 20 m/min. The coatweight after drying was 4.5 g/m². Subsequently the PSA was laminated onto the first assembly comprising PET film/PSA/PET release liner. The overall thickness of the PSA tape was 10 μm (without taking account of the PET release liners). The measurement of the tolerances (over a width of 50 cm/5 samples) gave a maximum deviation (4s) of 2.5 μm.

### Example 4

The PSA, polymer 1, is coated from solution onto a siliconized PET film (75 μm layer thickness, manufacturer Siliconature, silicone system graded with 10% CRA™). Coating is carried out using a comma bar with sag compensation. The coated PSA film is subsequently dried in a 40 m drying tunnel with temperature stages of 30° C./40° C./50° C./70° C./100° C. and 110° C. The web speed is 20 m/min. The coatweight after drying was 6.5 g/m². In a subsequent step a 4 μm PET film from Mitsubishi is laminated on.

In a second production run, polymer 1 is again coated from solution onto a siliconized PET film (75 μm layer thickness, manufacturer: Siliconature, easy release). Coating is carried out using a comma bar with sag compensation. The coated PSA film is subsequently dried in a 40 m drying tunnel with temperature stages of 30° C./40° C./50° G/70° C./100° C. and 110° C. The web speed is 20 m/min. The coatweight after drying was 6.5 g/m². Subsequently the PSA was laminated onto the first assembly comprising PET film/PSA/PET release liner. The overall thickness of the PSA tape was 16 μm (without taking account of the PET release liners). The measurement of the tolerances (over a width of 50 cm/5 samples) gave a maximum deviation (4s) of 3 μm.

### Reference Example 1

As a reference example a commercial double-sided polyester adhesive tape with a resin-modified acrylate adhesive is used [in this case tesa™ 4983 (PV0)], which is supplied for the adhesive bonding of LCD reflective films. The PSA tape has a total thickness of 30 μm and possesses a layer thickness tolerance (4s specification limit) of 6 μm. It is based on a resin-modified acrylate PSA and a 12 μm PET film carrier.

Reflective Film (Al Vapour Coating):

A transparent PET film 23 μm thick from Mitsubishi Polyester Films, of type RN, is vapour-coated on both sides with aluminium until a full-area aluminium layer has been applied to one side. The film was vapour-coated in a width of 300 mm by the sputtering method. In this method, positively charged, ionized argon gas is passed into a high-vacuum chamber. The charged ions then strike a negatively charged Al plate and, at the molecular level, detach particles of aluminium, which then deposit on the polyester film, which is passed over the plate.

Results

Examples 1 to 2 were tested together with reference example 1, first of all in accordance with test method D. The results are set out in Table 1.

TABLE 1

| | Bond strength to PC |
|---|---|
| Example | (Test D) |
| 1 | 0.5 N/cm |
| 2 | 2.1 N/cm |
| 3 | 2.0 N/cm |
| 4 | 3.7 N/cm |
| Reference 1 | 5.2 N/cm |

From the results from Table 1 it is apparent that examples 1 to 4 have all of the properties in the sense of double-sided adhesive tapes. Reference example 1 has the highest bond strengths as a result of the highest coatweight and the thickest carrier film layer.

In the following test, examples 1 to 4 and the reference example 1 were laminated onto the reflective film, and squares measuring 3×3 cm were punched out, and then applied to a PC housing with a pressure of 2 kg. After an applied time of 24 hours, the backlighting unit was bonded as a whole to an LC display, and then test methods B and C were carried out. The results are set out in Table 2.

| | Climatic test | Climatic test | Climatic cycling test | Climatic cycling test |
|---|---|---|---|---|
| Example | (Test B - 500 h) | (Test B - 1000 h) | (Test C - 500 h) | (Test C - 1000 h) |
| 1 | no lifting | no lifting | no lifting | no lifting |
| 2 | no lifting | no lifting | no lifting | no lifting |
| 3 | no lifting | no lifting | no lifting | no lifting |
| 4 | no lifting | no lifting | no lifting | no lifting |
| Reference 1 | no lifting | no lifting | no lifting | no lifting |

In no case was lifting of the reflective film observed after the climatic exposures. It was possible to show that the relatively thin double-sided PSA tapes have sufficiently high adhesion to hold the reflective film in the backlighting unit. Accordingly even constructions much thinner than 30 μm are suitable for this application.

In the final test, reflectance measurements were carried out in accordance with test method A. The reference used for measurement was the unbonded reflective film. Subsequently examples 1 to 4 and the reference example 1 were used for bonding the reflective film, and the reflectance values were determined (fresh values—measurement immediately after bonding). The values are listed in Table 3.

| | Reflectance (total) | Reflectance (diffuse) |
|---|---|---|
| Example | (Test A) | (Test A) |
| Reflective film | 86.9% | 24.2% |
| 1 | 86.6% | 28.5 |
| 2 | 86.4% | 30.2 |
| 3 | 86.4% | 30.8 |
| 4 | 86.4% | 31.5 |
| Reference 1 | 85.9% | 40.5 |

From the measurements it is apparent that examples 1 to 4 allow higher light reflection as a result of a more uniform surface. The values are only a short way above the light reflection of the unbonded original film. The unevennesses have a particularly large influence in the case of the diffuse component. Here, the reference example shows a significantly higher diffuse component. The light yield of the backlighting unit can therefore be increased using Examples 1 to 4.

1. Adhesive tape for a bonding reflective film in a backlighting unit of a liquid-crystal display system, the adhesive tape comprises a carrier film layer and two pressure-sensitive adhesive layers, wherein the adhesive tape has an overall thickness of less than 30 μm and a standard deviation in overall thickness of less than 1.25 μm.

2. Adhesive tape according to claim 1, wherein the standard deviation in overall thickness is less than 0.75 μm.

3. Adhesive tape according to claim 1, wherein a film material having a thickness of 0.5 to 12 μm, is used as the carrier film layer.

4. Adhesive tape according to claim 1, wherein a filmy polymer film is used as the carrier film layer.

5. Adhesive tape according to claim 1, wherein a capacitor film is used as carrier layer.

6. Adhesive tape according to claim 1, wherein the carrier film has a thickness tolerance of not more than 0.5 μm.

7. Adhesive tape according to claim 1, wherein the pressure-sensitive adhesive layers each do not exceed a weight per unit area of 10 g/m².

8. Adhesive tape according to claims 1 wherein, the overall thickness of the adhesive tape is between 2 and 29 μm.

9. A method for bonding a reflective film in a backlighting unit of a liquid-crystal display system, the method comprising:
bonding a reflective film in a housing of a backlighting unit with the adhesive tape according to claim 1.

10. Adhesive tape according to claim 1, wherein the standard deviation in overall thickness is less than 0.65 μm.

11. Adhesive tape according to claim 1, wherein the standard deviation in overall thickness is less than 0.5 μm.

12. Adhesive tape according to claim 3, wherein the thickness of the film material is 0.9 to 2 μm.

13. Adhesive tape according to claim 6, wherein the carrier film has a thickness tolerance of not more than 0.2 μm.

14. Adhesive tape according to claim 7, wherein the pressure-sensitive adhesive layers each do not exceed a weight per unit area of 3 g/m².

15. Adhesive tape according to claim 8, wherein the overall thickness of the adhesive tape is between 3 and 21 μm.
